(19) United States
(12) Patent Application Publication
(10) Pub. No.: US 2012/0258849 A1
(43) Pub. Date: Oct. 11, 2012

(54) Method of in situ synthesis by thermite reaction with sol-gel and FeNiCrTi/NiAl-A12O3 nanocomposite materials prepared by the method

(76) Inventors: Wenjun Xi, Beijing (CN); Neng Li, Beijing (CN); Wei Wu, Beijing (CN)

(21) Appl. No.: 13/514,557

(22) PCT Filed: Dec. 7, 2010
(86) PCT No.: PCT/CN10/79537

§ 371 Date: Jun. 7, 2012

(30) Foreign Application Priority Data
Dec. 8, 2009 (CN) 200910242107

(51) Int. Cl. C04B 35/78; C04B 35/657; B82Y 30/00

(52) U.S. Cl. 501/127; 977/773; 977/810; 977/811

(57) ABSTRACT

The invention prepares FeNiCrTi/NiAl-A12O3 nanocomposite materials by a method of in situ synthesis by thermite reaction with sol-gel. The nanocomposite material has high intensity at high temperature, high tenacity at room temperature, good oxidation resistance and good resistance to thermal corrosion. The method of the invention comprises: igniting thermite mixture to produce a high temperature melt and putting the high temperature melt into a fast-cooling mold, thereby obtaining the FeNiCrTi/NiAl—Al₂O₃ nanocomposite material. The thermite mixture contains Fe₂O₃, NiO, Cr₂O₃, CrO₃, Al and TiO₂ gel. The composite material is featured by small size of grains.

### CROSS REFERENCE TO RELATED INVENTIONS

This invention claims priority benefits under 35 U.S.C. 363 from International Patent Application no. PCT/CN2010/079537, filed in China on Dec. 7, 2010, and which in turn claims priority benefits under 35 U.S.C. 119 from Chinese National Application No. 200910242107.6, filed in China on Dec. 8, 2009.

### FIELD OF THE INVENTION

The present invention relates to a method for preparing FeNiCrTi/NiAl—Al₂O₃ nanocomposite materials by a method of in situ synthesis by thermite reaction with sol-gel. The nano-composite material has high temperature strength, excellent toughness at room-temperature, good oxidation resistance and hot corrosion resistance.

### BACKGROUND ART

Particle-reinforced metal-based composite materials (MMC) were obtained by adding to or growing in metal matrix reinforced phase of ceramic particles to obtain composite materials having both properties of metals (tenacity and ductility) and those of the reinforced particles (high hardness and high modulus). For example, Fe-based oxide-dispersion-strengthened (ODS) alloy prepared by mechanical alloyage (MA) has tiny uniformly dispersed Y₂O₃ particles grown in Fe alloy matrix, thus acquiring combined performance of anti-high-temperature-creeping and anti-oxidation. But alloy prepared in such a way suffers from high cost and complex process.

Al₂O₃ has the advantages of high hardness, high modulus, low free-energy generated by reaction, high melting point, low density, good oxidation resistance and etc., and is an excellent sort of strengthening particles.

For a long time, in the manufacture of Al₂O₃ particle strengthened Fe-based high-temperature alloy, emphasis has been placed on conventional composition of externally added strengthening objects, such as molding composition, powder metallurgy composition, ejection-deposition composition, and so on. These methods suffer some defects, including:

(1) the wettability between Al₂O₃ particles and Fe alloy matrix is typically bad, resulting in inferior interface combination between the strengthening phases and the matrix;

(2) the surface of Al₂O₃ particles is subject to contamination, which often leads to generation of other dopant, resulting in lowered combining strength between Al₂O₃ particles and the matrix;

(3) clusters are easily present during the addition of Al₂O₃ particles, leading to serious macroscopic component deviation of the composite material, large grain size, and deteriorated performances; and

(4) the process for manufacturing nano-Al₂O₃ particles is complex and associated with high cost, leading to high cost of such composite materials.

In-situ synthesis by thermite reaction is a recently developed approach for preparing composite materials. In-situ synthesis of thermite reaction produces a large amount of Al₂O₃ during reaction. Since Al₂O₃ has small density and poor wettability with the matrix, it is easily separated from the melt due to gravitation and floats on the topmost to form a layer of slag of alumina.

Thus, there is a need of certain measure to improve the wettability between Al₂O₃ and Fe matrix and/or allowing the Al₂O₃ produced by reaction to exist as strengthening particles staying in-situ.

### SUMMARY OF THE INVENTION

According to an aspect of the invention, there is provided a method for in-situ synthesis of FeNiCrTi/NiAl—Al₂O₃ nanocomposite material by thermite reaction, comprising:

igniting thermite mixture to produce a high temperature melt,

putting the high temperature melt into a fast-cooling mold, thereby obtaining the FeNiCrTi/NiAl—Al₂O₃ nanocomposite material.

According to a further aspect of the invention, the thermite mixture contains a gel of titanium dioxide.

According to a further aspect of the invention, the thermite mixture contains Fe₂O₃, NiO, Cr₂O₃, CrO₃, Al, and TiO₂ gel.

According to a further aspect of the invention, the thermite mixture contains:

31.7-36.6 Wt. % (% by weight) of Fe₂O₃;

7.0-11.9 Wt. % of NiO;

3.6-8.5 Wt. % of Cr₂O₃;

8.9-13.8 Wt. % of CrO₃;

23.8-28.7 Wt. % of Al; and

0.5-25.0 Wt. % of TiO₂ gel.

According to a further aspect of the invention, there is provided FeNiCrTi/NiAl—Al₂O₃ nanocomposite material prepared by the above-mentioned method.

### DESCRIPTION OF THE DRAWINGS

FIG. 1 shows XRD spectrum of a composite material according to an embodiment of the invention.

FIG. 2 shows TEM micrograph of the matrix of a composite material according to an embodiment of the invention.

FIG. 3 shows TEM micrograph of the matrix of a composite material according to another embodiment of the invention.

### DESCRIPTION OF EMBODIMENTS

According to an aspect of the invention, wettability between Al₂O₃ and matrix is improved by adding TiO₂ xerogel particles prepared by a method of adding sol-gel to thermite mixture, thus realizing a method for preparing FeNiCrTi/NiAl—Al₂O₃ nanocomposite materials by a method of in situ synthesis by thermite reaction with sol-gel and Al₂O₃— reinforced nanocomposite materials.

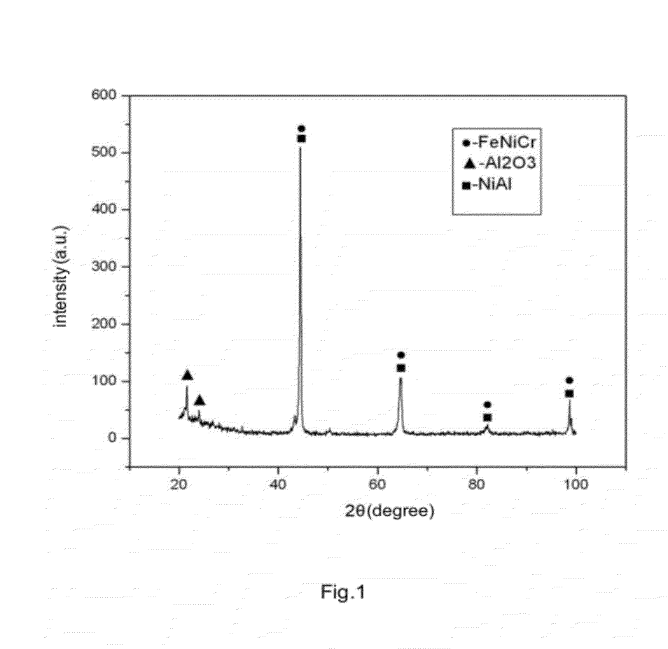

A nanocomposite material according to the invention consists of grains of nano-metric scale of matrix of (FeNiCrTi) and grains of nano-metric scale of intermetallic compound NiAl and Al₂O₃. FIG. 1 shows an X-ray diffraction (XRD) spectrum of a composite material according to an embodiment of the invention, which indicates that the composite material is composed of ferrite (α-FeNiCrTi) having a body-centered cubic structure, and Al₂O₃.

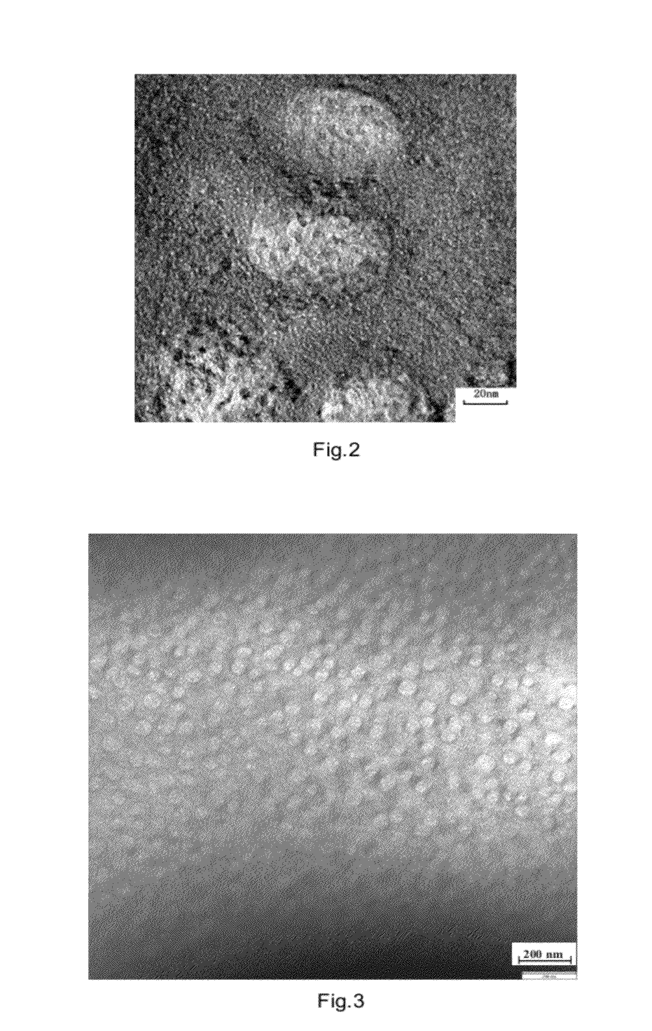

As indicated in FIGS. 2 and 3, it was shown by transmission electron microscope (TME) analysis that the matrix of the composite material was ferrite (α-FeNiCrTi). It is seen from FIGS. 2 and 3 that more than 90% of the grains are sized below about 10 nm, and the relatively larger grains of about 50 nm are considered to be areas of mixed phase formed by co-existence of mixed NiAl grains also sized below about 10 nm; and the relatively larger grains are uniformly dispersed in the matrix of the ferrite.

The super-fine grains in the composite material relates to the existence of Al₂O₃ particles which act as nucleation sites in the solidification process. In the reaction process of a method according to the invention, Al₂O₃ is formed first, and since first has a relatively high melting point (2303K), it is crystallized first under fast cooling in a copper mold. The presence of a large amount of Al₂O₃ grains as nucleation centers of crystallization greatly increases nucleation rate, and the Al₂O₃ particles effectively suppresses the growing of matrix grains. In addition, since the composite material is formed under fast cooling, there is no time for grains to grow up, leading to fine grains of the composite material.

Conventionally, as Al₂O₃ has small density and poor wettability with melt of iron-nickel-chromium alloy, it is easily separated from the melt and floats as a top-most layer and forms a layer of slag of alumina. In the invention, however, due to the effect of Ti element, wettability of Al₂O₃ with FeNiCrTi is improved, and the buoyant force generated by difference in densities between Al₂O₃ particles and the alloy melt is not sufficient to overcome the wetting combination force between them, leading to that Al₂O₃ particles can uniformly disperse in the matrix of the composite.

It can been seem from composition measured by energy dispersive microanalysis that Ti element concentrates at the vicinity of interfaces of Al₂O₃/matrix phases, while its concentration within Al₂O₃ grains or the matrix is much lower. This is due to that Ti has high chemical activity with respect to oxygen, and during the formation of the composite Ti concentrates towards interfaces of Al₂O₃/matrix phases by Gibbs chemisorption.

From a view point of structure, the surface of Al₂O₃ grains is covered by oxygen atoms; when such a surface contacts melted metals, atoms of the metals and those of oxygen generate affinity, which determines the wetting of the metals in liquid state with respect to Al₂O₃. Thus, concentration of Ti element of high oxygen activity at the interfaces allows great improvement of wetting of the matrix with respect to Al₂O₃.

Method according to an embodiment of the invention comprises:

preparing gel of titanium dioxide by sol-gel preparing process; and

preparing thermite mixture using said gel of titanium dioxide.

Method according to another embodiment of the invention comprises:

igniting said thermite mixture, thereby producing a high-temperature melt, and

pouring said high-temperature melt into a fast-cooling mold, making a FeNiCrTi/NiAl—Al₂O₃ nanocomposite material.

According to an embodiment of the invention, thermite mixture is prepared according to a predetermined composition table, and the thermite mixture is uniformly mixed and loaded into a crucible (made by, for example, graphite). Then, the above-mentioned operation of igniting thermite mixture is performed.

According to an embodiment of the invention, said crucible is wrapped by heat insulating material to prevent heat dissipation.

According to an embodiment of the invention, said crucible is sealed by aluminum foil at the bottom.

According to an embodiment of the invention, said crucible is pre-heated in a drying oven prior to said operation of igniting thermite.

According to an embodiment of the invention, said pre-heating step is carried out for 3 hours under 200° C.

According to an embodiment of the invention, said crucible after said pre-heating is placed over said mold.

According to an embodiment of the invention, said mold is preferably a mold made of copper.

According to an embodiment of the invention, said step of igniting thermite comprised igniting thermite by a powered-on tungsten filament, the reaction lasted for 8-seconds, with large amount of heat being released and the entire product being in melted state.

According to another embodiment of the invention, said method comprises allowing said high-temperature melt to pierce by melting said aluminum foil, thus allowing said high-temperature melt to pour into said copper mold to make FeNiCrTi/NiAl—Al₂O₃ nanocomposite material.

Comparing to conventional methods, method according to the invention for preparing nanocomposite materials by in situ synthesis has remarkable advantages, including:
since strengthening phase is grown in matrix by reaction, core-forming, and growing, these strengthening phases are thermal-dynamically stable;
the surface of the strengthening phase is free of contaminant, so incompatibility at the interface between the matrix phase and the strengthening phase is eliminated;
the strengthening phase is tiny and uniformly dispersed, while its amount can be adjusted over a wide range, and parts of complex and/or large size can be manufactured by simple process at low cost;
Al₂O₃ has high hardness, high modulus, and low reaction-generated free energy; intermetallic compound NiAl has high melting point, low density, good heat conductivity and excellent oxidation resistance;
Al₂O₃ and NiAl grains and metallic matrix are all produced by chemical reaction of in-situ synthesis;
the surface of Al₂O₃ and NiAl grains are clean and has high combination strength with the matrix;
NiAl having CsCl type structure has very similar lattice constants as that of α-FeNiCr solid solution, at 0.286 nm and 0.287 nm respectively, so it is likely to obtain co-lattice strengthening similar to that of γ phase (Ni₃Al) in nickel-based high temperature alloy;
it is expected that the produced composite material has high intensity at high temperature, high tenacity at room temperature, good oxidation resistance and good resistance to thermal corrosion.

Al₂O₃ has small density and bad wettability with the matrix, and combination of Al₂O₃ with the matrix can hardly be realized by conventional process of externally adding strengthening body. Nano grains of TiO₂ can effectively enhance wettability of Al₂O₃ with the matrix and at the same time remarkable suppress the size of grains. Preparing nano grains of TiO₂ by sol-gel method enjoys simple process, easy operation, low synthesis temperature, easy control of conditions, and good moldability. Seed formation can be promoted during hydrolysis process, and growth of seeds and cluster of grains can be suppressed, thus obtaining a product with good uniformity and high purity. Four major parameters having substantive effects on sol-gelation process during reaction are pH value of solution, concentration of solution, reaction temperature and reaction time. Extremely fine powder as small as nano scale can be produced with the method of the invention.

According to an embodiment of the invention, the thermite mixture used contains:

Fe₂O₃;

NiO;

Cr₂O₃;

CrO₃;

Al; and

TiO₂ gel.

According to an embodiment of the invention, the thermite mixture contains 0.5-25.0 Wt. % of TiO₂ gel.

According to an embodiment of the invention, the thermite mixture used contains:

31.7-36.6 Wt. % (% by weight) of Fe₂O₃;

7.0-11.9 Wt. % of NiO; 3.6-8.5 Wt. % of Cr₂O₃;

8.9-13.8 Wt. % of CrO₃;

23.8-28.7 Wt. % of Al; and

0.5-25.0 Wt. % of TiO₂ gel.

According to an embodiment of the invention, the TiO₂ gel was prepared by glacial acetic acid method.

According to another embodiment of the invention, the TiO₂ gel was prepared by TiCl₄ hydrolysis method.

According to a further embodiment of the invention, the TiO₂ gel was prepared by stearic acid method.

According to an embodiment of the invention, said TiO₂ gel was prepared by:

adding glacial acetic acid to a beaker containing absolute ethyl alcohol at room temperature, and then adding tetrabutyl titanate into the beaker, and stirring the mixture until it is mixed uniformly to obtain a transparent solution of faint yellow color;

slowly dripping deionized water into said transparent solution of faint yellow color while stirring the latter, to obtain uniform transparent sol on finish of the dripping;

keeping on stirring the solution to obtain translucent wet gel by slow evaporation of solvent;

keeping on stirring and maintain temperature by water bath until the reaction system became a whole block of gel that could not flow,

placing and aging in air;

drying to obtain faint yellow powder;

grinding the faint yellow powder to obtain TiO₂ gel powder.

According to another embodiment of the invention, said TiO₂ gel was prepared by:

dripping a predetermined amount of TiCl₄ into distilled water;

dripping aqueous solution of ammonia sulfate and concentrated hydrochloric acid to the obtained aqueous solution of titanium tetrachloride and stirring;

heating the mixture obtained in the previous step and keeping the temperature for a predetermined time;

adding stronger ammonia water to adjust pH value to about 6, followed by cooling to room temperature, aging and filtering;

drying the deposit at room temperature;

grinding the deposit to obtain TiO₂ gel powder.

According to yet another embodiment of the invention, said TiO₂ gel was prepared by:

solving stearic acid in butyl titanate;

heating until the stearic acid melted;

stirring by magnetic force the product until it formed a translucent sol;

naturally cooling the translucent sol to form gel;

placing and aging the gel in air;

drying the gel to obtain crystal;

grinding the crystal to obtain TiO₂ gel powder.

### EMBODIMENTS

### Embodiment 1

(1) TiO₂ gel was prepared using glacial acetic acid method. Mol ratio of reactants was: tetrabutyl titanate:alcohol:water:glacial acetic acid=1:10:4:1. Glacial acetic acid was added to beaker containing absolute ethyl alcohol at room temperature, and then tetrabutyl titanate was added into the beaker, and the mixture was stirred for 0.5 hour to allow it to be mixed uniformly to obtain a transparent solution of faint yellow color; deionized water was dripped at about 12 drips/minute into said transparent solution of faint yellow color while violently stirring the latter, to obtain uniform transparent sol on finish of the dripping; stirring the solution for about additional 1 hour to obtain a translucent wet gel by slow evaporation of solvent; stirring was kept and temperature was maintained by water bath until the reaction system became a whole block of gel that could not flow. The product was placed and aged in air for more than 12 hours, and was dried at 80° C. for about 20 hours to obtain faint yellow powder; the faint yellow powder was carefully ground to obtain TiO₂ gel powder.

(2) Thermite mixture was prepared according to Table 1. The thermite was mixed uniformly and placed in a graphite crucible. The bottom of the crucible was sealed by aluminum foil. The crucible was placed in a drying oven and preheated for 3 hours at 200° C.

TABLE 1
components of thermite mixture

| Comp. | Fe₂O₃ | NiO | Cr₂O₃ | CrO₃ | Al | TiO₂ gel |
|---|---|---|---|---|---|---|
| Wt. % | 36.6 | 11.9 | 8.5 | 13.8 | 28.7 | 0.5 |

| | |
|---|---|
| Size (μm) | <=45 |

(3) The crucible was placed above a copper mold. The thermite was ignited by powered-on tungsten filament. The aluminum foil was pieced by high temperature melt, which poured into the preset copper mold, thus obtaining a FeNiCrTi/NiAl—Al₂O₃ nanocomposite material.

(4) The structural state of the obtained nanocomposite material was observed using X-ray diffraction.

(5) The micrograph of the obtained nanocomposite material was observed using Transmission Electron Microscope (TEM). Its components were analyzed using energy dispersive microanalysis.

(6) The micro structure of the obtained nanocomposite material was observed using electron probe microanalysis (EPMA), and it was found that the material is tight and almost free of any blowhole.

(7) Rod of 6 mm in diameter and 9 mm in height was made using the obtained material, as sample for compression test, which was carried out under room temperature on an MTS (MTS System Corporation) material testing machine. The yield strength (σ_{sc}) under compression of the sample was measured as σ_{sc}=1085 MPa.

### Embodiment 2

(1) TiO₂ gel was prepared using glacial acetic acid method. Mol ratio of reactants was: tetrabutyl titanate:alcohol:water:glacial acetic acid=1:10:4:1. Glacial acetic acid was added to beaker containing absolute ethyl alcohol at room temperature, and then tetrabutyl titanate was added into the beaker, and the mixture was stirred for 0.5 hour to allow it to be mixed uniformly to obtain a transparent solution of faint yellow color; deionized water was dripped at about 12 drips/minute into said transparent solution of faint yellow color while violently stirring the latter, to obtain uniform transparent sol on finish of the dripping; stirring the solution for about additional 1 hour to obtain a translucent wet gel by slow evaporation of solvent; stirring was kept and temperature was maintained by water bath until the reaction system became a whole block of gel that could not flow. The product was placed and aged in air for more than 12 hours, and was dried at 80° C. for about 20 hours to obtain faint yellow powder; the faint yellow powder was carefully ground to obtain TiO₂ gel powder.

(2) Thermite mixture was prepared according to Table 2. The thermite was mixed uniformly and placed in a graphite crucible. The bottom of the crucible was sealed by aluminum foil. The crucible was placed in a drying oven and preheated for 3 hours at 200° C.

TABLE 2
components of thermite mixture

| Comp. | Fe₂O₃ | NiO | Cr₂O₃ | CrO₃ | Al | TiO₂ gel |
|---|---|---|---|---|---|---|
| Wt. % | 36.5 | 11.8 | 8.4 | 13.7 | 28.6 | 1.0 |

| | |
|---|---|
| Size(μm) | <=45 |

(3) The crucible was placed above a copper mold. The thermite mixture was ignited by powered-on tungsten filament. The aluminum foil was pieced by high temperature melt, which poured into the preset copper mold, thus obtaining a FeNiCrTi/NiAl—Al₂O₃ nanocomposite material.

(4) The structural state of the obtained nanocomposite material was observed using X-ray diffraction.

(5) The micrograph of the obtained nanocomposite material was observed using Transmission Electron Microscope (TEM). Its components were analyzed using energy dispersive microanalysis.

(6) The micro structure of the obtained nanocomposite material was observed using electron probe microanalysis (EPMA), and it was found that the material is tight, the number of blowholes increased slightly but effect of the increase was not obvious.

(7) Rod of 6 mm in diameter and 9 mm in height was made using the obtained material, as sample for compression test, which was carried out under room temperature on an MTS material testing machine. The yield strength (σ_{sc}) under compression of the sample was measured as σ_{sc}=1325 MPa.

### Embodiment 3

(1) TiO₂ gel was prepared using glacial acetic acid method. Mol ratio of reactants was: tetrabutyl titanate:alcohol:water:glacial acetic acid=1:10:4:1. Glacial acetic acid was added to beaker containing absolute ethyl alcohol at room temperature, and then tetrabutyl titanate was added into the beaker, and the mixture was stirred for 0.5 hour to allow it to be mixed uniformly to obtain a transparent solution of faint yellow color; deionized water was dripped at about 12 drips/minute into said transparent solution of faint yellow color while violently stirring the latter, to obtain uniform transparent sol on finish of the dripping; stirring the solution for about additional 1 hour to obtain a translucent wet gel by slow evaporation of solvent; stirring was kept and temperature was maintained by water bath until the reaction system became a whole block of gel that could not flow. The product was placed and aged in air for more than 12 hours, and was dried at 80° C. for about 20 hours to obtain faint yellow powder; the faint yellow powder was carefully ground to obtain TiO₂ gel powder.

(2) Thermite mixture was prepared according to Table 3. The thermite was mixed uniformly and placed in a graphite crucible. The bottom of the crucible was sealed by aluminum foil. The crucible was placed in a drying oven and preheated for 3 hours, at 200° C.

TABLE 3
components of thermite mixture

| Comp. | Fe₂O₃ | NiO | Cr₂O₃ | CrO₃ | Al | TiO₂ gel |
|---|---|---|---|---|---|---|
| Wt. % | 35.7 | 11.0 | 7.6 | 12.9 | 27.8 | 5.0 |

| | |
|---|---|
| Size (μm) | <=45 |

(3) The crucible was placed above a copper mold. The thermite mixture was ignited by powered-on tungsten filament. The aluminum foil was pieced by high temperature melt, which poured into the preset copper mold, thus obtaining a FeNiCrTi/NiAl—Al₂O₃ nanocomposite material.

(4) The structural state of the obtained nanocomposite material was observed using X-ray diffraction.

(5) The micrograph of the obtained nanocomposite material was observed using Transmission Electron Microscope (TEM). Its components were analyzed using energy dispersive microanalysis.

(6) The micro structure of the obtained nanocomposite material was observed using electron probe microanalysis (EPMA), and it was found that the number of blowholes increased further, and formation of the material was affected.

(7) Rod of 6 mm in diameter and 9 mm in height was made using the obtained material, as sample for compression test, which was carried out under room temperature on an MTS material testing machine. The yield strength (σ_{sc}) under compression of the sample was measured as σ_{sc}=412 MPa.

### Embodiment 4

(1) TiO₂ gel was prepared using glacial acetic acid method. Mol ratio of reactants was: tetrabutyl titanate:alcohol:water:glacial acetic acid=1:10:4:1. Glacial acetic acid was added to beaker containing absolute ethyl alcohol at room temperature, and then tetrabutyl titanate was added into the beaker, and the mixture was stirred for 0.5 hour to allow it to be mixed uniformly to obtain a transparent solution of faint yellow color; deionized water was dripped at about 12 drips/minute into said transparent solution of faint yellow color while violently stirring the latter, to obtain uniform transparent sol on finish of the dripping; stirring the solution for about additional 1 hour to obtain a translucent wet gel by slow evaporation of solvent; stirring was kept and temperature was maintained by water bath until the reaction system became a whole block of gel that could not flow. The product was placed and aged in air for more than 12 hours, and was dried at 80° C. for about 20 hours to obtain faint yellow powder; the faint yellow powder was carefully ground to obtain TiO₂ gel powder.

(2) Thermite mixture was prepared according to Table 4. The thermite was mixed uniformly and placed in a graphite crucible. The bottom of the crucible was sealed by aluminum foil. The crucible was placed in a drying oven and preheated for 3 hours at 200° C.

TABLE 4
components of thermite mixture

| Comp. | Fe₂O₃ | NiO | Cr₂O₃ | CrO₃ | Al | TiO₂ gel |
|---|---|---|---|---|---|---|
| Wt. % | 34.7 | 10.0 | 6.6 | 11.9 | 26.8 | 10.0 |

| | |
|---|---|
| Size (μm) | <=45 |

(3) The crucible was placed above a copper mold. The thermite mixture was ignited by powered-on tungsten filament. The aluminum foil was pieced by high temperature melt, which poured into the preset copper mold, thus obtaining a FeNiCrTi/NiAl—Al₂O₃ nanocomposite material.

(4) The structural state of the obtained nanocomposite material was observed using X-ray diffraction.

(5) The micrograph of the obtained nanocomposite material was observed using Transmission Electron Microscope (TEM). Its components were analyzed using energy dispersive microanalysis.

(6) The micro structure of the obtained nanocomposite material was observed using electron probe microanalysis (EPMA), and it was found that the number of blowholes increased obviously, and formation of the material became difficult.

### Embodiment 5

(1) TiO₂ gel was prepared using glacial acetic acid method. Mol ratio of reactants was: tetrabutyl titanate:alcohol:water:glacial acetic acid=1:10:4:1. Glacial acetic acid was added to beaker containing absolute ethyl alcohol at room temperature, and then tetrabutyl titanate was added into the beaker, and the mixture was stirred for 0.5 hour to allow it to be mixed uniformly to obtain a transparent solution of faint yellow color; deionized water was dripped at about 12 drips/minute into said transparent solution of faint yellow color while violently stirring the latter, to obtain uniform transparent sol on finish of the dripping; stirring the solution for about additional 1 hour to obtain a translucent wet gel by slow evaporation of solvent; stirring was kept and temperature was maintained by water bath until the reaction system became a whole block of gel that could not flow. The product was placed and aged in air for more than 12 hours, and was dried at 80° C. for about 20 hours to obtain faint yellow powder; the faint yellow powder was carefully ground to obtain TiO₂ gel powder.

(2) Thermite mixture was prepared according to Table 5. The thermite was mixed uniformly and placed in a graphite crucible. The bottom of the crucible was sealed by aluminum foil. The crucible was placed in a drying oven and preheated for 3 hours at 200° C.

TABLE 5
components of thermite mixture

| Comp. | Fe₂O₃ | NiO | Cr₂O₃ | CrO₃ | Al | TiO₂ gel |
|---|---|---|---|---|---|---|
| Wt. % | 31.7 | 7.0 | 3.6 | 8.9 | 23.8 | 25.0 |

| | |
|---|---|
| Size (μm) | <=45 |

(3) The crucible was placed above a copper mold. The thermite mixture was ignited by powered-on tungsten filament. The aluminum foil was pieced by high temperature melt, which poured into the preset copper mold, thus obtaining a FeNiCrTi/NiAl—Al₂O₃ nanocomposite material.

(4) The structural state of the obtained nanocomposite material was observed using X-ray diffraction.

(5) The micrograph of the obtained nanocomposite material was observed using Transmission Electron Microscope (TEM). Its components were analyzed using energy dispersive microanalysis.

(6) The micro structure of the obtained nanocomposite material was observed using electron probe microanalysis (EPMA), and it was found that large number of blowholes dispersed in the material; and formation of the material was difficult.

Brief summary: it was observed from Embodiments 1-5 that with the increase of TiO₂ gel in the thermite mixture prepared by glacial acetic acid method, blowholes in the prepared composite material increased, and yield strength increased first and then decreased.

### Embodiment 6

(1) TiO₂ gel was prepared using TiCl₄ hydrolysis method. Titanium tetrachloride (chemically pure) was used as precursor, which was violently stirred under cold water bath. A predetermined amount of TiCl₄ was dripped into distilled water, and aqueous solution of ammonia sulfate and concentrated hydrochloric acid was dripped to the obtained aqueous solution of titanium tetrachloride. The obtained solution was stirred, and the temperature during the mixing process was controlled to be below 15° C. The mixture was then heated to 95° C. and the temperature was retained for 1 hour. Then concentrated aqueous ammonia was added, and pH value was adjusted to about 6. The mixture was then cooled to room temperature, aged for 12 hours, and filtered. The deposit was dried at room temperature, and was then carefully ground to obtain white TiO₂ gel powder.

(2) Thermite mixture was prepared according to Table 6. The thermite was mixed uniformly and placed in a graphite crucible. The bottom of the crucible was sealed by aluminum foil. The crucible was placed in a drying oven and preheated for 3 hours at 200° C.

TABLE 6
components of thermite mixture

| Comp. | Fe₂O₃ | NiO | Cr₂O₃ | CrO₃ | Al | TiO₂ gel |
|---|---|---|---|---|---|---|
| Wt. % | 36.6 | 11.9 | 8.5 | 13.8 | 28.7 | 0.5 |

| | |
|---|---|
| Size (μm) | <=45 |

(3) The crucible was placed above a copper mold. The thermite mixture was ignited by powered-on tungsten filament. The aluminum foil was pieced by high temperature melt, which poured into the preset copper mold, thus obtaining a FeNiCrTi/NiAl—Al₂O₃ nanocomposite material.

(4) The structural state of the obtained nanocomposite material was observed using X-ray diffraction.

(5) The micrograph of the obtained nanocomposite material was observed using Transmission Electron Microscope (TEM). Its components were analyzed using energy dispersive microanalysis.

(6) The micro structure of the obtained nanocomposite material was observed using electron probe microanalysis (EPMA), and it was found that the material is tight and almost free of any blowhole.

(7) Rod of 6 mm in diameter and 9 mm in height was made using the obtained material, as sample for compression test, which was carried out under room temperature on an MTS material testing machine. The yield strength (σ_{sc}) under compression of the sample was measured as σ_{sc}=1053 MPa.

### Embodiment 7

(1) TiO₂ gel was prepared using TiCl₄ hydrolysis method. titanium tetrachloride (chemically pure) was used as precursor, which was violently stirred under cold water bath. A predetermined amount of TiCl₄ was dripped into distilled water, and aqueous solution of ammonia sulfate and concentrated hydrochloric acid was dripped to the obtained aqueous solution of titanium tetrachloride. The obtained solution was stirred, and the temperature during the mixing process was controlled to be below 15° C. The mixture was then heated to 95° C. and the temperature was retained for 1 hour. Then concentrated aqueous ammonia was added, and pH value was adjusted to about 6. The mixture was then cooled to room temperature, aged for 12 hours, and filtered. The deposit was dried at room temperature, and was then carefully ground to obtain white TiO₂ gel powder.

(2) Thermite mixture was prepared according to Table 7. The thermite was mixed uniformly and placed in a graphite crucible. The bottom of the crucible was sealed by aluminum foil. The crucible was placed in a drying oven and preheated for 3 hours at 200° C.

TABLE 7
components of thermite mixture

| Comp. | Fe₂O₃ | NiO | Cr₂O₃ | CrO₃ | Al | TiO₂ gel |
|---|---|---|---|---|---|---|
| Wt. % | 36.5 | 11.8 | 8.4 | 13.7 | 28.6 | 1.0 |

| | |
|---|---|
| Size (μm) | <=45 |

(3) The crucible was placed above a copper mold. The thermite mixture was ignited by powered-on tungsten filament. The aluminum foil was pieced by high temperature melt, which poured into the preset copper mold, thus obtaining a FeNiCrTi/NiAl—Al₂O₃ nanocomposite material.

(4) The structural state of the obtained nanocomposite material was observed using X-ray diffraction.

(5) The micrograph of the obtained nanocomposite material was observed using Transmission Electron Microscope (TEM). Its components were analyzed using energy dispersive microanalysis.

(6) The micro structure of the obtained nanocomposite material was observed using electron probe microanalysis (EPMA), and it was found that the number of blowholes increased but not obvious.

(7) Rod of 6 mm in diameter and 9 mm in height was made using the obtained material, as sample for compression test, which was carried out under room temperature on an MTS material testing machine. The yield strength (σ_{sc}) under compression of the sample was measured as σ_{sc}=1308 MPa.

### Embodiment 8

(1) TiO₂ gel was prepared using TiCl₄ hydrolysis method. titanium tetrachloride (chemically pure) was used as precursor, which was violently stirred under cold water bath. A predetermined amount of TiCl₄ was dripped into distilled water, and aqueous solution of ammonia sulfate and concentrated hydrochloric acid was dripped to the obtained aqueous solution of titanium tetrachloride. The obtained solution was stirred, and the temperature during the mixing process was controlled to be below 15° C. The mixture was then heated to 95° C. and the temperature was retained for 1 hour. Then concentrated aqueous ammonia was added, and pH value was adjusted to about 6. The mixture was then cooled to room temperature, aged for 12 hours, and filtered. The deposit was dried at room temperature, and was then carefully ground to obtain white TiO₂ gel powder.

(2) Thermite mixture was prepared according to Table 8. The thermite was mixed uniformly and placed in a graphite crucible. The bottom of the crucible was sealed by aluminum foil. The crucible was placed in a drying oven and preheated for 3 hours at 200° C.

TABLE 8
components of thermite mixture

| Comp. | Fe₂O₃ | NiO | Cr₂O₃ | CrO₃ | Al | TiO₂ gel |
|---|---|---|---|---|---|---|
| Wt. % | 35.7 | 11.0 | 7.6 | 12.9 | 27.8 | 5.0 |

| | |
|---|---|
| Size (μm) | <=45 |

(3) The crucible was placed above a copper mold. The thermite mixture was ignited by powered-on tungsten filament. The aluminum foil was pieced by high temperature melt, which poured into the preset copper mold, thus obtaining a FeNiCrTi/NiAl—Al₂O₃ nanocomposite material.

(4) The structural state of the obtained nanocomposite material was observed using X-ray diffraction.

(5) The micrograph of the obtained nanocomposite material was observed using Transmission Electron Microscope (TEM). Its components were analyzed using energy dispersive microanalysis.

(6) The micro structure of the obtained nanocomposite material was observed using electron probe microanalysis (EPMA), and it was found that the number of blowholes increased further and formation of the material was affected.

(7) Rod of 6 mm in diameter and 9 mm in height was made using the obtained material, as sample for compression test, which was carried out under room temperature on an MTS material testing machine. The yield strength (σ_{sc}) under compression of the sample was measured as σ_{sc}=379 MPa.

### Embodiment 9

(1) TiO₂ gel was prepared using TiCl₄ hydrolysis method. titanium tetrachloride (chemically pure) was used as precursor, which was violently stirred under cold water bath. A predetermined amount of TiCl₄ was dripped into distilled water, and aqueous solution of ammonia sulfate and concentrated hydrochloric acid was dripped to the obtained aqueous solution of titanium tetrachloride. The obtained solution was stirred, and the temperature during the mixing process was controlled to be below 15° C. The mixture was then heated to 95° C. and the temperature was retained for 1 hour. Then concentrated aqueous ammonia was added, and pH value was adjusted to about 6. The mixture was then cooled to room temperature, aged for 12 hours, and filtered. The deposit was dried at room temperature, and was then carefully ground to obtain white TiO₂ gel powder.

(2) Thermite mixture was prepared according to Table 9. The thermite was mixed uniformly and placed in a graphite crucible. The bottom of the crucible was sealed by aluminum foil. The crucible was placed in a drying oven and preheated for 3 hours at 200° C.

TABLE 9
components of thermite mixture

| Comp. | Fe₂O₃ | NiO | Cr₂O₃ | CrO₃ | Al | TiO₂ gel |
|---|---|---|---|---|---|---|
| Wt. % | 34.7 | 10.0 | 6.6 | 11.9 | 26.8 | 10.0 |

| | |
|---|---|
| Size (μm) | <=45 |

(3) The crucible was placed above a copper mold. The thermite mixture was ignited by powered-on tungsten filament. The aluminum foil was pieced by high temperature melt, which poured into the preset copper mold, thus obtaining a FeNiCrTi/NiAl—Al₂O₃ nanocomposite material.

(4) The structural state of the obtained nanocomposite material was observed using X-ray diffraction.

(5) The micrograph of the obtained nanocomposite material was observed using Transmission Electron Microscope (TEM). Its components were analyzed using energy dispersive microanalysis.

(6) The micro structure of the obtained nanocomposite material was observed using electron probe microanalysis (EPMA), and it was found that the number of blowholes increased obviously and formation of the material was difficult.

### Embodiment 10

(1) TiO₂ gel was prepared using TiCl₄ hydrolysis method. titanium tetrachloride (chemically pure) was used as precursor, which was violently stirred under cold water bath. A predetermined amount of TiCl₄ was dripped into distilled water, and aqueous solution of ammonia sulfate and concentrated hydrochloric acid was dripped to the obtained aqueous solution of titanium tetrachloride. The obtained solution was stirred, and the temperature during the mixing process was controlled to be below 15° C. The mixture was then heated to 95° C. and the temperature was retained for 1 hour. Then concentrated aqueous ammonia was added, and pH value was adjusted to about 6. The mixture was then cooled to room temperature, aged for 12 hours, and filtered. The deposit was dried at room temperature, and was then carefully ground to obtain white TiO₂ gel powder.

(2) Thermite mixture was prepared according to Table 10. The thermite was mixed uniformly and placed in a graphite crucible. The bottom of the crucible was sealed by aluminum foil. The crucible was placed in a drying oven and preheated for 3 hours at 200° C.

TABLE 10
components of thermite mixture

| Comp. | Fe₂O₃ | NiO | Cr₂O₃ | CrO₃ | Al | TiO₂ gel |
|---|---|---|---|---|---|---|
| Wt. % | 31.7 | 7.0 | 3.6 | 8.9 | 23.8 | 25.0 |

| | |
|---|---|
| Size (μm) | <=45 |

(3) The crucible was placed above a copper mold. The thermite mixture was ignited by powered-on tungsten filament. The aluminum foil was pieced by high temperature melt, which poured into the preset copper mold, thus obtaining a FeNiCrTi/NiAl—Al₂O₃ nanocomposite material.

(4) The structural state of the obtained nanocomposite material was observed using X-ray diffraction.

(5) The micrograph of the obtained nanocomposite material was observed using Transmission Electron Microscope (TEM). Its components were analyzed using energy dispersive microanalysis.

(6) The micro structure of the obtained nanocomposite material was observed using electron probe microanalysis (EPMA), and it was found that the number of blowholes increased obviously and formation of the material was difficult.

Brief summary: it was concluded from embodiments 6-10 that with the increase of TiO₂ gel in the thermite mixture prepared by TiCl₄ hydrolysis method, blowholes in the prepared composite material increased, and yield strength increased first and then decreased.

### Embodiment 11

(1) TiO₂ gel was prepared using stearic acid method. Mol ratio of the reactants was: tetrabutyl titanate:stearic acid=1:1.5. Predetermined amount of stearic acid was weighed and dissolved in tetrabutyl titanate, and the temperature was raised until stearic acid melted. Stirring by magnetic force was performed for 2-3 hours to form translucent sol; which formed gel after natural cooling. The product was then placed and aged in air for over 12 hours. After that, the product was dried at 80° C. for about 20 hours to obtain crystals of faint yellow color, which was carefully ground to obtain white power of TiO₂ gel.

(2) Thermite mixture was prepared according to Table 11. The thermite was mixed uniformly and placed in a graphite crucible. The bottom of the crucible was sealed by aluminum foil. The crucible was placed in a drying oven and preheated for 3 hours at 200° C.

TABLE 11
components of thermite mixture

| Comp. | Fe₂O₃ | NiO | Cr₂O₃ | CrO₃ | Al | TiO₂ gel |
|---|---|---|---|---|---|---|
| Wt. % | 36.6 | 11.9 | 8.5 | 13.8 | 28.7 | 0.5 |

| | |
|---|---|
| Size (μm) | <=45 |

(3) The crucible was placed above a copper mold. The thermite mixture was ignited by powered-on tungsten filament. The aluminum foil was pieced by high temperature melt, which poured into the preset copper mold, thus obtaining a FeNiCrTi/NiAl—Al₂O₃ nanocomposite material.

(4) The structural state of the obtained nanocomposite material was observed using X-ray diffraction.

(5) The micrograph of the obtained nanocomposite material was observed using Transmission Electron Microscope (TEM). Its components were, analyzed using energy dispersive microanalysis.

(6) The micro structure of the obtained nanocomposite material was observed using electron probe microanalysis (EPMA), and it was found that the material was tight and almost free of any blowhole.

(7) Rod of 6 mm in diameter and 9 mm in height was made using the obtained material, as sample for compression test, which was carried out under room temperature on an MTS material testing machine. The yield strength (σ_{sc}) under compression of the sample was measured as σ_{sc}=1031 MPa.

### Embodiment 12

(1) TiO₂ gel was prepared using stearic acid method. Mol ratio of the reactants was tetrabutyl titanate:stearic acid=1:1.5. Predetermined amount of stearic acid was weighed and dissolved in tetrabutyl titanate, and the temperature was raised until stearic acid melted. Stirring by magnetic force was performed for 2-3 hours to form translucent sol; which formed gel after natural cooling. The product was then placed and aged in air for over 12 hours. After that, the product was dried at 80° C. for about 20 hours to obtain crystals of faint yellow color, which was carefully ground to obtain white power of TiO₂ gel.

(2) Thermite mixture was prepared according to Table 12. The thermite was mixed uniformly and placed in a graphite crucible. The bottom of the crucible was sealed by aluminum foil. The crucible was placed in a drying oven and preheated for 3 hours at 200° C.

TABLE 12
components of thermite mixture

| Comp. | Fe₂O₃ | NiO | Cr₂O₃ | CrO₃ | Al | TiO₂ gel |
|---|---|---|---|---|---|---|
| Wt. % | 36.5 | 11.8 | 8.4 | 13.7 | 28.6 | 1.0 |

| | |
|---|---|
| Size (μm) | <=45 |

(3) The crucible was placed above a copper mold. The thermite mixture was ignited by powered-on tungsten filament. The aluminum foil was pieced by high temperature melt, which poured into the preset copper mold, thus obtaining a FeNiCrTi/NiAl—Al₂O₃ nanocomposite material.

(4) The structural state of the obtained nanocomposite material was observed using X-ray diffraction.

(5) The micrograph of the obtained nanocomposite material was observed using Transmission Electron Microscope (TEM). Its components were analyzed using energy dispersive microanalysis.

(6) The micro structure of the obtained nanocomposite material was observed using electron probe microanalysis (EPMA), and it was found that the number of blowholes increased slightly without any obvious effect.

(7) Rod of 6 mm in diameter and 9 mm in height was made using the obtained material, as sample for compression test, which was carried out under room temperature on an MTS material testing machine. The yield strength (σ_{sc}) under compression of the sample was measured as σ_{sc}=1265 MPa.

### Embodiment 13

(1) TiO₂ gel was prepared using stearic acid method. Mol ratio of the reactants was: tetrabutyl titanate:stearic acid=1:1.5. Predetermined amount of stearic acid was weighed and dissolved in tetrabutyl titanate, and the temperature was raised until stearic acid melted. Stirring by magnetic force was performed for 2-3 hours to form translucent sol; which formed gel after natural cooling. The product was then placed and aged in air for over 12 hours. After that, the product was dried at 80° C. for about 20 hours to obtain crystals of faint yellow color, which was carefully ground to obtain white power of TiO₂ gel.

(2) Thermite mixture was prepared according to Table 13. The thermite was mixed uniformly and placed in a graphite crucible. The bottom of the crucible was sealed by aluminum foil. The crucible was placed in a drying oven and preheated for 3 hours at 200° C.

TABLE 13
components of thermite mixture

| Comp. | Fe₂O₃ | NiO | Cr₂O₃ | CrO₃ | Al | TiO₂ gel |
|---|---|---|---|---|---|---|
| Wt. % | 35.7 | 11.0 | 7.6 | 12.9 | 27.8 | 5.0 |

| | |
|---|---|
| Size (μm) | <=45 |

(3) The crucible was placed above a copper mold. The thermite mixture was ignited by powered-on tungsten filament. The aluminum foil was pieced by high temperature melt, which poured into the preset copper mold, thus obtaining a FeNiCrTi/NiAl—Al₂O₃ nanocomposite material.

(4) The structural state of the obtained nanocomposite material was observed using X-ray diffraction.

(5) The micrograph of the obtained nanocomposite material was observed using Transmission Electron Microscope (TEM). Its components were analyzed using energy dispersive microanalysis.

(6) The micro structure of the obtained nanocomposite material was observed using electron probe microanalysis (EPMA), and it was found that the number of blowholes increased further and formation of the material was affected.

(7) Rod of 6 mm in diameter and 9 mm in height was made using the obtained material, as sample for compression test, which was carried out under room temperature on an MTS material testing machine. The yield strength (σ_{sc}) under compression of the sample was measured as σ_{sc}=364 MPa.

### Embodiment 14

(1) TiO₂ gel was prepared using stearic acid method. Mol ratio of the reactants was: tetrabutyl titanate:stearic acid=1:1.5. Predetermined amount of stearic acid was weighed and dissolved in tetrabutyl titanate, and the temperature was raised until stearic acid melted. Stirring by magnetic force was performed for 2-3 hours to form translucent sol; which formed gel after natural cooling. The product was then placed and aged in air for over 12 hours. After that, the product was dried at 80° C. for about 20 hours to obtain crystals of faint yellow color, which was carefully ground to obtain white power of TiO₂ gel.

(2) Thermite mixture was prepared according to Table 14. The thermite was mixed uniformly and placed in a graphite crucible. The bottom of the crucible was sealed by aluminum foil. The crucible was placed in a drying oven and preheated for 3 hours at 200° C.

TABLE 14
components of thermite mixture

| Comp. | Fe₂O₃ | NiO | Cr₂O₃ | CrO₃ | Al | TiO₂ gel |
|---|---|---|---|---|---|---|
| Wt. % | 34.7 | 10.0 | 6.6 | 11.9 | 26.8 | 10.0 |

| | |
|---|---|
| Size (μm) | <=45 |

(3) The crucible was placed above a copper mold. The thermite mixture was ignited by powered-on tungsten filament. The aluminum foil was pieced by high temperature melt, which poured into the preset copper mold, thus obtaining a FeNiCrTi/NiAl—Al₂O₃ nanocomposite material.

(4) The structural state of the obtained nanocomposite material was observed using X-ray diffraction.

(5) The micrograph of the obtained nanocomposite material was observed using Transmission Electron Microscope (TEM). Its components were analyzed using energy dispersive microanalysis.

(6) The micro structure of the obtained nanocomposite material was observed using electron probe microanalysis (EPMA), and it was found that the number of blowholes increased obviously and formation of the material was difficult.

### Embodiment 15

(1) TiO₂ gel was prepared using stearic acid method. Mol ratio of the reactants was: tetrabutyl titanate:stearic acid=1:1.5. Predetermined amount of stearic acid was weighed and dissolved in tetrabutyl titanate, and the temperature was raised until stearic acid melted. Stirring by magnetic force was performed for 2-3 hours to form translucent sol; which formed gel after natural cooling. The product was then placed and aged in air for over 12 hours. After that, the product was dried at 80° C. for about 20 hours to obtain crystals of faint yellow color, which was carefully ground to obtain white power of TiO₂ gel.

(2) Thermite mixture was prepared according to Table 15. The thermite was mixed uniformly and placed in a graphite crucible. The bottom of the crucible was sealed by aluminum foil. The crucible was placed in a drying oven and preheated for 3 hours at 200° C.

TABLE 15
components of thermite mixture

| Comp. | Fe₂O₃ | NiO | Cr₂O₃ | CrO₃ | Al | TiO₂ gel |
|---|---|---|---|---|---|---|
| Wt. % | 31.7 | 7.0 | 3.6 | 8.9 | 23.8 | 25.0 |

| | |
|---|---|
| Size (μm) | <=45 |

(3) The crucible was placed above a copper mold. The thermite mixture was ignited by powered-on tungsten filament. The aluminum foil was pieced by high temperature melt, which poured into the preset copper mold, thus obtaining a FeNiCrTi/NiAl—Al₂O₃ nanocomposite material.

(4) The structural state of the obtained nanocomposite material was observed using X-ray diffraction.

(5) The micrograph of the obtained nanocomposite material was observed using Transmission Electron Microscope (TEM). Its components were analyzed using energy dispersive microanalysis.

(6) The micro structure of the obtained nanocomposite material was observed using electron probe microanalysis (EPMA), and it was found that large number of blowholes dispersed in the material, and formation of the material was difficult.

Brief summary: it was concluded from embodiments 11-15 that with the increase of TiO₂ gel in the thermite mixture prepared by stearic acid method, blowholes in the prepared composite material increased, and yield strength increased first and then decreased.

It is to be understood that the above description of the invention is for description but not for limitation. Various changes, variations, and/or modifications to the above-described embodiments are possible within the scope of the claims below, wherein we claim:

1. Method for in-situ synthesis of FeNiCrTi/NiAl—Al₂O₃ nanocomposite material by thermite reaction, comprising:
igniting thermite mixture to produce a high temperature melt,
putting the high temperature melt into a fast-cooling mold, thereby obtaining the FeNiCrTi/NiAl—Al₂O₃ nanocomposite material.

2. Method of claim 1, wherein the thermite mixture contains gel of titanium dioxide.

3. Method of claim 1, wherein the thermite mixture contains Fe₂O₃, NiO, Cr₂O₃, CrO₃, Al, and TiO₂ gel.

4. Method of claim 3, wherein the thermite mixture contains:
31.7-36.6 Wt. % of Fe₂O₃;
7.0-11.9 Wt. % of NiO;
3.6-8.5 Wt. % of Cr₂O₃;
8.9-13.8 Wt. % of CrO₃
23.8-28.7 Wt. % of Al; and
0.5-25.0 Wt. % of TiO₂ gel.

5. Method of claim 3, further comprising:
loading said thermite mixture into a crucible,
sealing said crucible at its bottom by aluminum foil,
wrapping said crucible by heat insulating material to prevent heat dissipation,
placing said crucible a dryer and pre-heating said crucible loaded with said thermite mixture for a predetermined time, and taking out said crucible,
placing said crucible above said fast-cooling mold,
allowing said high temperature melt to piece said aluminum foil,
thereby allowing the high temperature melt to pour into the fast-cooling mold to form the FeNiCrTi/NiAl—Al₂O₃ nanocomposite material.

6. Method of claim 3, wherein said TiO₂ gel was prepared by:
adding glacial acetic acid to a container containing absolute ethyl alcohol at room temperature, and then adding tetrabutyl titanate into the container, and stirring the mixture until it is mixed uniformly to obtain a transparent solution of faint yellow color;
slowly dripping deionized water into said transparent solution of faint yellow color while stirring the latter, to obtain uniform transparent sol on finish of the dripping;
keeping on stirring the solution to obtain translucent wet gel by evaporation of solvent;
keeping on stirring and maintain temperature by water bath until the reaction system became a whole block of gel that could not flow,
placing and aging the obtained product in air;
drying the obtained product to obtain faint yellow powder;
grinding the faint yellow powder to obtain TiO₂ gel powder.

7. Method of claim 3, wherein said TiO₂ gel was prepared by:
dripping a predetermined amount of titanium tetrachloride (TiCl₄) into distilled water;
dripping aqueous solution of ammonia sulfate and concentrated hydrochloric acid to the obtained aqueous solution of titanium tetrachloride and stirring the obtained mixture;
heating the mixture obtained in the previous step and keeping the temperature for a predetermined time;
adding stronger ammonia water to adjust pH value to about 6, followed by cooling to room temperature, aging and filtering to obtain deposit;
drying the deposit at room temperature;
grinding the deposit to obtain TiO₂ gel powder.

8. Method of claim 3, wherein said TiO₂ gel was prepared by:
solving stearic acid in butyl titanate;
heating the product until the stearic acid melted;
stirring by magnetic force the product until it forms a translucent sol;
naturally cooling the translucent sol to form gel;
placing and aging the gel in air;
drying the gel to obtain crystal;
grinding the crystal to obtain TiO₂ gel powder.

9. FeNiCrTi/NiAl—Al₂O₃ nanocomposite material, wherein
said nanocomposite material consists of matrix of grains of FeNiCrTi, grains of NiAl, grains of Al₂O₃, and grains of NiAl—Al₂O₃ mixed phase,
wherein
said grains of FeNiCrTi are ferrite of α-FeNiCrTi sized below about 10 nm,
said grains of NiAl and grains of Al₂O₃ are sized smaller than 10 nm, and
said grains of NiAl—Al₂O₃ mixed phase are uniformly dispersed in said matrix of grains of FeNiCrTi.
